(19) United States
(12) Patent Application Publication
(10) Pub. No.: US 2011/0192726 A1
(43) Pub. Date: Aug. 11, 2011

(54) DEVICE AND METHOD FOR DETECTION OF ANALYTE FROM A SAMPLE

(75) Inventors: Yu Chen, Singapore (SG); Julien Reboud, Singapore (SG); En Hou Philip Wong, Singapore (SG); Kyaw Thu Moe, Singapore (SG); Se Ngie Winston Shim, Singapore (SG); Qasem Ramadan, Singapore (SG); Kum Cheong Tang, Singapore (SG)

(73) Assignees: Agency for Science ,Technology and Research; Singapore Health Services Pte. Ltd

(21) Appl. No.: 13/122,727

(22) PCT Filed: Sep. 1, 2009
(86) PCT No.: PCT/SG2009/000309

§ 371 Date: Apr. 5, 2011

Related U.S. Application Data
(60) Provisional application No. 61/193,154, filed on Oct. 31, 2008.

(51) Int. Cl. G01N 27/447; G01N 27/453

(52) U.S. Cl. 204/547; 204/643

(57) ABSTRACT

There is presently provided a device for detecting an analyte particle in a sample. The device comprises a chamber having an interior surface upon which is located an electrode array. The electrode array comprises pairs of electrodes, each pair having an inner electrode and an outer electrode that substantially surrounds the inner electrode. Each pair of electrodes is coated with a capture molecule that recognises and binds the analyte particle that is to be identified and quantified. The device uses a combination of dielectrophoresis and impedance measurements to capture and measure analyte particles from a sample.

### FIELD OF THE INVENTION

The present invention relates to devices and methods for detecting the presence of a particular analyte particle within a sample, including the presence of a particular cell type within a sample.

### BACKGROUND OF THE INVENTION

In various clinical applications, it is often desirable to identify the presence of a particular cell type in a sample, and to quantify the number of cells of that cell type that are present in the sample.

For example, circulating endothelial progenitor cells (EPC) are circulating stem cells from the bone marrow that are involved in vascular surfaces repair (endothelial damage repair). Their number in blood is a biomarker of clinical interest, linked to the assessment of risk factors in cardiovascular diseases and for choice of certain therapeutic approaches.

For patients suffering from a blocked coronary artery, one of the main treatments is stent implant. There are different types of stents. Genous™ stent (Orbusneich, HK) is a new type of stent, which captures circulating EPCs to promote vascular healing. Clinical trials have demonstrated reduction in side effects compared to other kinds of stents. The treatment efficiency is often directly correlated to a patient's EPC level. However, there is currently no simple and robust method to detect circulating EPCs and stent selection is therefore often based on the individual physician's experience rather than knowledge of the actual EPC count.

Conventional EPC detection relies on flow-cytometry analysis (FACS), which is a quantitative measurement technique. However, this technique usually requires off-site analysis and therefore is not an efficient aid when deciding on the type of stent to deploy in the patient. Using FACS to determine EPC count involves two major time-consuming steps that are typically performed by a skilled laboratory technician. First, peripheral blood mononuclear cells (PBMNC) are purified from a blood sample (typically an hour to complete). Next, the actual FACS is performed, which typically takes 4 to 5 hours to complete. FACS also requires relatively large sample volumes to achieve the necessary accuracy to reliably detect rare circulating cells in a mixture of PBMNC.

Having available a bedside EPC detection system would reduce total analysis time in situations where knowledge of the EPC count is required. If the sensitivity (i.e. the lower limit of EPC detection) of such a detection system were within the clinical relevant range (EPC level in blood: 0.01%-1% PBMNC; 4000-11000 PBMNC/μl blood), such a system would have the potential to assist when a physician is deciding on the type of stent to deploy in a patient. As well, a bedside EPC detection system would provide a tool for monitoring of patients' health and would be useful in clinical diagnosis and assessment of the efficacy of drug treatment.

Recently, microfluidic detection of low-level circulating cells has been developed using a strategy similar to FACS analysis in which the cells are stained with a specific marker and the marker is then detected on a microfluidic chip (Yao-Nan Wang, et al. Anal Chem Acta. 2006 626(1): 97-103). However, this approach still relies on a label-based method that is highly time-consuming, and optical detection which is difficult to integrate since the ability to differentiate data within an image can be cumbersome. As well, when using FACS-based analysis, it is necessary to properly control the fluid flow, necessitating complex fluidic systems.

### SUMMARY OF THE INVENTION

The present invention provides a device that is useful for identifying the presence of a particular type of analyte particle within a sample, including cells, bacteria, viruses, proteins, nucleic acids, and micro- and nano-beads having analyte particles immobilised on the bead surface, and for quantifying the number of analyte particles of that particular type within the sample.

Thus, the present invention provides a device that is useful for identifying the presence of a particular cell type within a sample and which may be used for quantifying the number of cells of that particular cell type within the sample.

The device is designed to use a combination of dielectrophoresis (DEP) and immobilised capture molecules, such as antibodies, to trap the desired analyte particle type, in combination with impedance measurements to quantify the number of trapped analyte particles.

The device comprises a chamber having an interior surface upon which is located an electrode array. The electrode array comprises pairs of electrodes, each pair having an inner electrode, for example a disc electrode, and an outer electrode that substantially surrounds the inner electrode, for example a horse-shoe electrode. Each inner electrode (and optionally each outer electrode) is coated with a capture molecule, for example a cell-specific antibody, which capture molecule will recognise and bind the analyte particle, for example a cell-surface marker on a cell type that is to be identified and quantified. The non-electrode portion of the interior surface of the chamber (i.e. the portion of the surface that is not covered by an electrode) may be coated with an analyte-repellent material, for example a cell-repellent material to reduce non-specific binding of cells to the interior of the chamber and to the electrodes.

The electrodes within the electrode array are electrically connected in such a manner that they may be switched between a first mode and a second mode.

In the first mode, the inner electrodes together act as a collective electrode and the outer electrodes together act as a collective counter-electrode in order to generate a non-uniform electric field that gives rise to dielectrophoresis.

In the second mode, each inner electrode functions individually as a working electrode while the outer electrodes function together as a reference/counter electrode for impedance measurement at each individual working electrode. Such a design conveniently allows for the use of a single metal masking process when manufacturing the device, which is more cost- and time-efficient as compared with other devices that involve separate electrode systems for analyte particle trapping and detection methods and which therefore require two metal masking processes.

The dual operating modes for the electrode array provides large electrodes to supply the electric field for the dielectrophoretic trapping of analyte particles such as cells, with the electric field minimum occurring at the centres of the inner electrodes, thus efficiently directing analyte particles towards the immobilised capture molecules, and individual working electrodes for impedance measurements to provide a more sensitive and efficient quantification of trapped analyte particles.

Optionally, the chamber may include inlet and/or outlet ports in fluid connection with a microfluidic pump system, to allow for washing of the chamber once the targeted analyte particles are bound on the inner electrode surface via the immobilised antibodies.

The device of the present invention may be designed to allow for multiplexing of analyte particle detection.

The device and methods of using the device of the present invention therefore may provide a fast, efficient and label-free approach to detecting and quantifying a particular type of target analyte particle in a sample. As well, since the sample may be deposited directly into the chamber rather than using a flow-through system, small sample volumes may be used along with sequential batch loading, avoiding large dead volumes within the device and the resulting loss of target analyte particles through non-specific adhesion or sedimentation of analyte particles.

The methods of the present invention use DEP to trap analyte particles contained within the sample, including negative DEP, which may allow for the use of a buffer solution for sample preparation that can also serve as a conductive medium, for example phosphate buffered saline (PBS) solution for trapping and detecting cells, which can be used for the cell trapping step (DEP) and the cell detecting step (impedance measurement).

The use of negative DEP results in trapping of target analyte particles at electrical field minima, which occur at the centre of the inner electrodes rather than along the electrode edge as with positive DEP, thus leading to the concentration of the target analyte particles directly on the impedance detection electrodes and subsequently enhancing impedance detection sensitivity without the need for labelling of the sample. As well, the use of individual working electrodes to measure impedance, and thus levels of target analyte particles, provides a more sensitive detection method as the ratio between the area of each inner electrode and that of the combined reference/counter outer electrode is quite high.

The use of analyte-repellent coating on the device surface not covered by electrodes reduces non-specific adhesion of analyte particles and increases specific detection of the target analyte particles. This may be helpful when the concentration of target analyte particles is much lower than the concentration of other non-target particles that may be present in the sample, and assists with particle flow and removal during any washing steps.

Thus, in one aspect the present invention provides a device for detecting target analyte particles in a sample, comprising a chamber having an interior surface; an electrode array on the interior surface, the electrode array comprising one or more electrode pairs, each of the one or more electrode pairs comprising an inner electrode and an outer electrode at least substantially surrounding the inner electrode; one or more capture molecules immobilised on a surface of each of the inner electrodes for capturing the target analyte particles; and a controller operably interconnected with the electrode array to selectively apply a voltage to the outer electrodes and the inner electrodes to (i) generate a dielectrophoretic field in the vicinity of the electrode array for concentrating target analyte particles at the electrode array for capture by the capture molecules; and (ii) sense impedance changes at each inner electrode, to detect captured target analyte particles.

The dielectrophoretic field generated may be a negative dielectrophoretic field.

The device may further comprise an inlet and an outlet of the chamber, each of the inlet and outlet in fluid communication with a microfluidic pump system. The area of the interior surface not covered by electrodes may be coated with an analyte-repellent material.

The device may comprise two or more electrode pairs and a first portion of the inner electrodes has a first type of one or more capture molecules immobilised thereon and a second portion of the inner electrodes has a second type of one or more capture molecules immobilised thereon.

The analyte particles may be cells, bacteria, viruses, proteins, nucleic acids, microbeads or nanobeads, and the one or more capture molecules may be antibodies. In a particular embodiment, the capture molecules are anti-CD34 antibodies and the target analyte particles are endothelial progenitor cells.

In another aspect, the present invention provides a method of determining concentration of target analyte particles in a sample, comprising adding a sample volume to a chamber of a device, the chamber having an electrode array located on an interior surface of the chamber, the electrode array comprising one or more electrode pairs, each of the one or more electrode pairs comprising an inner electrode and an outer electrode surrounding the inner electrode, each of the inner electrodes having one or more capture molecules immobilised thereon; applying a voltage to the outer electrodes and the inner electrodes to generate a dielectrophoretic field in the vicinity of the electrode array, thereby concentrating target analyte particles present in the sample volume at the electrode array; capturing the target analyte particles by specifically binding the target analyte particles with the capture molecules and forming a remaining sample volume; replacing the remaining sample volume in the chamber with an impedance buffer solution to the chamber suitable for conducting impedance measurements; measuring impedance at each inner electrode; and comparing the measured impedance with impedance measured in the absence of any target analyte particles and correlating any difference in impedance obtained with the concentration of target analyte particles in the sample.

The dielectrophoretic field may be a negative dielectrophoretic field. The method may optionally include incubating the sample volume for a period of time following application of the dielectrophoretic field and prior to replacing the remaining sample volume and/or washing the chamber with a wash buffer solution prior to adding the impedance buffer solution.

In one embodiment, the electrode array comprises two or more electrode pairs and a first portion of the inner electrodes has a first type of one or more capture molecules immobilised thereon and a second portion of the inner electrodes has a second type of one or more capture molecules immobilised thereon, and the comparing is performed separately for the measured impedance obtained for the first portion of inner electrodes and for the measured impedance obtained for the second portion of inner electrodes.

The analyte particles may be cells, bacteria, viruses, proteins, nucleic acids, microbeads or nanobeads, and the one or more capture molecules may be antibodies. In a particular embodiment, the antibodies are anti-CD34 antibodies and the target cells are endothelial progenitor cells.

In one embodiment, the sample volume is a first sample volume and the method further includes adding a second sample volume after the adding and before the measuring, and repeating the applying and the replacing prior to measuring the impedance.

In another embodiment, the sample volume is a first sample volume and further comprising adding a second sample volume after the measuring and repeating the applying, the replacing and the measuring.

In one embodiment, the analyte particles are cells, the method further comprising, after the measuring, incubating the cells in the chamber under conditions that allow for cell growth, and then repeating the applying, the capturing, the replacing the impedance buffer, the measuring and the comparing.

Optionally, the measuring comprises measuring a first impedance, and the method further comprising incubating the captured target analyte particles in the impedance buffer for a pre-determined period of time, measuring a second impedance and then comparing the second measured impedance with the first measured impedance and correlating any difference in impedance obtained with the change in the sample over the pre-determined period of time.

In one embodiment of the method, the measuring of impedance may comprise measuring a second impedance, and the method further comprises, prior to measuring the second impedance measuring a first impedance at each inner electrode; and incubating the captured target analyte particles in the impedance buffer for a pre-determined period of time; wherein the reference measured impedance is the first measured impedance and correlating further comprises correlating any difference in impedance obtained with an increase in concentration of target analyte particles in the sample.

The incubating may be performed under conditions that allow for cell growth. A supplement may be added prior to the incubating step. The step of applying the voltage may be repeated prior to measuring the second impedance.

In another aspect, the present invention provides a method of determining concentration of target analyte particles in a sample, comprising adding a sample volume to a chamber of a device, the chamber having an electrode array located on an interior surface of the chamber, the electrode array comprising one or more electrode pairs, each of the one or more electrode pairs comprising an inner electrode and an outer electrode surrounding the inner electrode, each of the inner electrodes having one or more capture molecules immobilised thereon; applying a voltage to the outer electrodes and the inner electrodes to generate a dielectrophoretic field in the vicinity of the electrode array, thereby concentrating target analyte particles present in the sample volume at the electrode array; capturing the target analyte particles by specifically binding the target analyte particles with the capture molecules and forming a remaining sample volume; replacing the remaining sample volume in the chamber with an impedance buffer solution to the chamber suitable for conducting impedance measurements; measuring a first impedance at each inner electrode; incubating the captured target analyte particles in the impedance buffer for a pre-determined period of time; measuring a second impedance at each inner electrode; and comparing the second measured impedance with the first measured impedance and correlating any difference in impedance obtained with an increase in concentration of target analyte particles in the sample.

The incubating may be performed under conditions that allow for cell growth. A supplement may be added prior to the incubating step.

The method may include repeating the applying prior to the measuring the second impedance.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

The figures, which illustrate, by way of example only, embodiments of the present invention, depict the following.

FIG. 1 shows a side view of a chamber of one embodiment of the device.

FIG. 2 shows a top view of an electrode array of one embodiment of the device.

FIG. 3 is a schematic view of an electrode array of one embodiment of the device.

FIG. 4 shows capture molecules immobilised on the electrodes in one embodiment of the device.

FIG. 5 shows a schematic depiction of one embodiment of the device.

FIG. 6 is a schematic depiction of a system incorporating one embodiment of the device.

FIG. 7 is a fluorescent micrograph showing an electrode pair; left panel: control with cell-repellent material surrounding the electrode surfaces; right panel: electrode pair treated with a fluorescent protein bound by a chemical linker with a free thiol group to react with the gold electrode surface and a carboxyl-amine linkage with the immobilised protein, showing selective coating of the fluorescent protein on the electrode surfaces and low non-specific binding on the rest of the surface.

FIG. 8 is micrographs of electrodes in which the of electrodes have immobilised anti-CD34 antibody on their surfaces and cell-repellent material on the non-electrode surfaces; top: specific attachment of CD34+ cells before and after washing (only the cells in contact with antibody (binding) are retained, the cells on the cell-repellent material are washed away); bottom: no attachment of CD34− cells under the same conditions.

FIG. 9 is micrographs of electrode surfaces showing the extent of cell trapping without (top) or with (bottom) the use of negative DEP, with an incubation period of 12 (left) or 20 (right) minutes.

FIG. 10 is a graph of results of impedance measurements due to cell attachment on the electrode surface (left) and a micrograph of the electrode surface following capture of CD34+ cells and after washing (right).

FIG. 11 depicts simulation results of electrical field distribution across an electrode pair.

FIG. 12 shows the results of the negative DEP for CD34+ cell trapping on the electrode centre.

FIG. 13 is a graph of impedance measurement results demonstrating determination of lower detection limit, using a sample of Jurkat cells (CD34−) spiked with known quantities of CD34+ cells.

FIG. 14 is a graph of impedance measurements taken after each batch loading of a multiple batch loading of a sample of Jurkat cells (CD34−) spiked with known quantities of CD34+ cells on an electrode with immobilised anti-CD34 antibody.

FIG. 15 is micrographs of electrode pairs with immobilised anti-CD34 antibody taken after each batch loading of a multiple batch loading of a sample of Jurkat cells (CD34−) spiked with known quantities of CD34+ cells.

FIG. 16 is a graph of impedance measurements taken after each batch loading of a multiple batch loading of a sample of Jurkat cells (CD34−) without any CD34+ cells on an electrode with immobilised anti-CD34 antibody.

FIG. 17 is micrographs of electrode pairs with immobilised anti-CD34 antibody taken after each batch loading of a multiple batch loading of a sample of Jurkat cells (CD34−) without any CD34+ cells.

FIG. 18 is a schematic diagram of a multiplexed system with 3 chambers and a single electrode array having different capture molecules immobilised in different portions of the array (inset). In the multiplexed system: Chamber 1 has immobilised capture molecule antibody A; Chamber 2 has immobilised capture molecule antibody B; and Chamber 3 has immobilised capture molecule antibodies A and B. The inset panel shows a single electrode array with different capture molecules located on particular individual electrode surfaces: as indicated in the legend, going from left to right, the first three pairs of electrodes have only antibody A immobilised on the surface of the inner electrode, the next three electrodes have only antibody B immobilised on the surface, the next four electrodes have one mixture of antibodies A and B; the last two electrodes, as well as the small electrodes in between the electrode pairs have a different mixture of immobilised antibodies A and B.

FIG. 19 is a schematic drawing of top, bottom and cross-sectional views of a chamber of one embodiment of the device.

FIG. 20 is schematic drawings of various embodiments of chambers of the device.

FIG. 21 is a flow diagram depicting one embodiment of the method.

### DETAILED DESCRIPTION

There is provided an analyte particle detection device and a method of using such a device to detect target analyte particles within a sample. The detection device may be designed to allow for integration into a portable unit, for example a hand-held unit that may be used in a clinical or hospital setting for use at a patient bedside.

Dielectrophoresis is a technique often used for separating microparticles. A dielectrophoretic field is a varying electrical field that is spatially non-uniform. Such an electric field generates unequal electrical polarization dipoles in a neutral dielectric particle, including for example a cell. The interaction of the induced dipoles with the electric field results in a dielectrophoretic force.

The dielectrophoretic force experienced by a particle is dependent on a number of factors. The amplitude and frequency of the applied non-uniform electric field will directly affect the dielectrophoretic force experienced by a particle. A particle's own structural and chemical properties will also affect its dielectric properties and thus its movement within a dielectrophoretic field. For example, a biological cell's morphology, structural architecture, composition, cytoplasmic conductance, cell membrane resistance, capacitance and permittivity will all affect a cell's polarizability.

Also affecting the dielectrophoretic force experienced by a particle are the dielectric properties of the surrounding medium within which the particle is suspended. A particle that is more polarisable than its suspending medium will experience a net force toward high electric field regions (positive DEP), while a particle that is less polarisable than its suspending medium will experience a net force toward low electric field regions (negative DEP).

The device described herein is designed to concentrate target analyte particles on electrodes located on a surface, using positive or negative dielectrophoresis. However, negative dielectrophoresis has the advantage of allowing for the use of a conductive buffer solution for sample preparation that can be used as the dielectrophoretic buffer for subsequent impedance measurement. Furthermore, by using negative dielectrophoresis, the centre of the working electrodes exhibit field minima, thus directing target analyte particles to the centre of electrodes, improving the impedance measurements. In contrast, if positive dielectrophoresis is used, analyte particles are directed and trapped at the field maxima, usually located at the edges of the electrodes. At least the inner electrodes have a capture molecule immobilised on their surfaces for capturing target analyte particles from the sample. The number of particles captured by the immobilised target molecules is determined by measuring the effect on the impedance of the system at each working electrode.

The electrodes consist of paired electrodes arranged within an electrode array. The device is designed so that the outer electrodes function together as a collective electrode and the inner electrodes may selectively act together as a counter electrode to generate the non-uniform electrode field at the surface in order to concentrate any analyte particles contained in the sample, but also so that each inner electrode within a pair of inner and outer electrodes can selectively function individually as a working electrode against the combined outer electrodes functioning as a collective reference electrode for impedance measurements to determine the number of cells captured by immobilised capture molecules on the surface of the working electrode.

However, for certain applications, it may be desirable to have the electrodes connected in such a manner that a portion of the inner electrodes function together or each inner electrode functions individually against the outer electrodes functioning together in the first mode for application of the non-uniform electric field. Also, in the second mode for impedance measurement, it may be desirable to have the inner electrodes functioning together, although this approach is less sensitive than each inner working electrode functioning individually.

Although the following description is provided in terms of capturing a target cell from solution, the analyte particle may be any analyte particle that is or that behaves as a neutral dielectric particle and thus may be subjected to a dielectric force applied by a non-uniform electric field, including a negative dielectric field. For example, the analyte particle may be a cell, a bacterium, a virus, a protein, a nucleic acid, or a micro- or nano-bead having an immobilised or captured biological molecule or cell on its surface. For example, a microbead having a ligand or marker that is recognised by a capture molecule immobilised on the electrode surface may be used. The microbead may also have a capture molecule specific for a target analyte, which may be bound to the bead prior to addition to the chamber or after the bead is captured by the immobilised capture molecule by addition of a sample containing the target analyte to the chamber containing the captured microbeads.

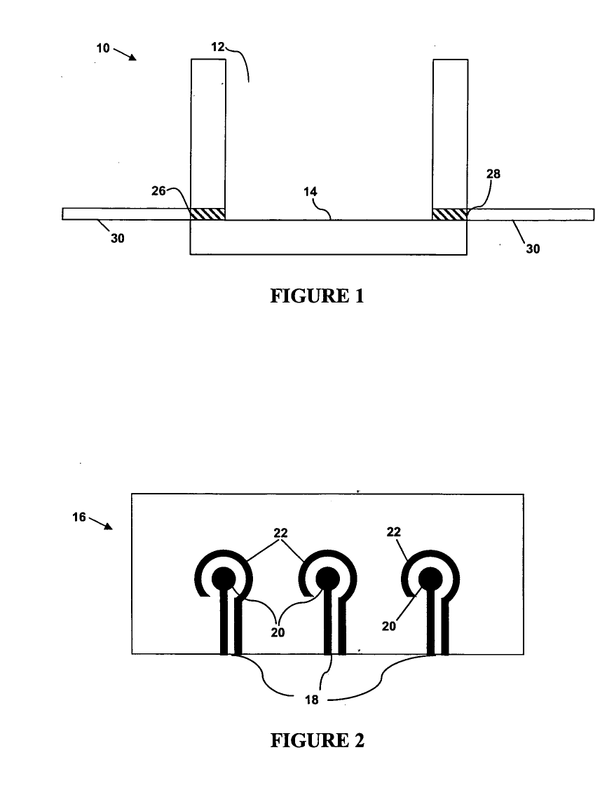

With reference to FIG. 1, device 10 has a chamber 12 for receiving a sample. Chamber 12 has a surface 14, which is located within chamber 12 so as to be in contact with sample fluid when a sample is added to the chamber. For example, surface 14 is located on the floor of chamber 12 in the depicted embodiment.

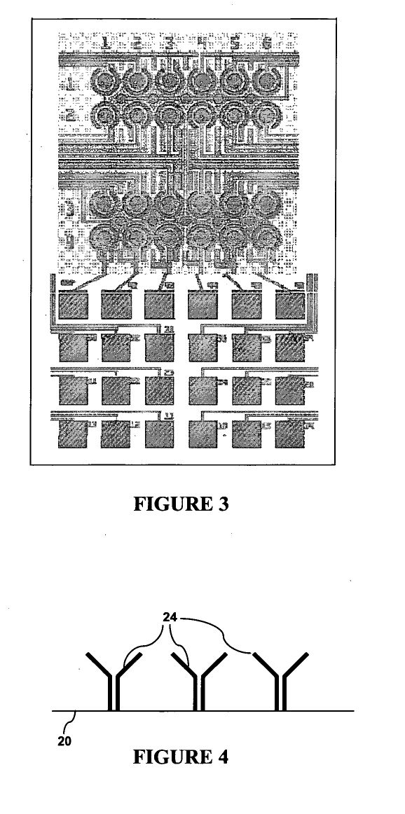

Located on surface 14 is electrode array 16, shown in FIG. 2. Electrode array is made up of pairs of electrodes 18, with each electrode pair 18 consisting of inner electrode 20 and outer electrode 22. FIG. 3 shows a schematic depiction of an electrode array.

Generally, inner electrode 20 may be of any shape and outer electrode 22 is formed as a narrow strip that at least substantially surrounds the perimeter of inner electrode 20. As depicted in FIG. 2, inner electrode 20 is a disc electrode and outer electrode 22 is a horseshoe electrode, but inner electrode 20 may be for example, triangular, square, oval or rectangular and outer electrode 22 may be a complementary shape that surrounds the perimeter of inner electrode 20.

The electric field has local maxima that occur at the edges of both the inner and outer electrodes and local minima that occur at the centre of both the inner and outer electrodes. Thus, the gradient of the electric field, which is linked to the intensity of the dielectrophoretic force, is most intense towards the edges of the electrodes. The negative dielectrophoretic force is thus directed away from the edges, towards the centre of the inner electrode.

The strength of the electric field generated is related to the geometry of the electrodes within the array, as well as the voltage used to generate the electric field. As will be appreciated, too high a voltage may have a negative impact on cells. However, in order to direct and trap cells at the centre of the inner electrode surface, the outer electrode is designed as a thin strip at least substantially surrounding the inner electrode, thus distributing the field minima and maxima so as to result in a focussing of cells at the centre of the inner electrode.

As shown in FIG. 4, capture molecule 24 is immobilised on the surface of inner electrode 20 and optionally on outer electrode 22. Capture molecule 24 may be any molecule that is capable of specifically binding a target cell contained in a sample by specifically binding to a cell surface marker present on the target cell. Capture molecule 24 may be for example, a protein, an antibody including a monoclonal antibody, an antibody fragment, a ligand, a receptor, an inhibitor, a small molecule, a nucleic acid molecule, a hormone or a non-cleavable substrate analogue. Capture molecule 24 may be a single specific capture molecule or it may be a combination of two or more different capture molecules that will bind to different molecules on the surface of the same target cell types or different target cell types. Capture molecule 24 specifically binds a target cell, meaning with that capture molecule 24 binds a target cell with greater affinity and selectivity than it binds other cell types that may be present in the sample along with the target cell. Capture molecule 24 may be immobilised on the surface of inner electrodes 20 and optionally outer electrodes 22 using standard methods known in the art. For example, a covalent cross-linker may be Used to cross-link a functional group in capture molecule 24 to the surface of inner electrodes 20 and optionally outer electrodes 22.

The remainder of surface 14 that is not covered by inner electrodes 20 and outer electrodes 22 may be coated with a cell-repellent material to reduce non-specific adherence of cells to surface 14. Cell-repellent materials include poly-ethylene glycol, polystyrene, bovine sera albumin, zwitterionic molecules such as betaine, as well as other hydrophobic coatings such as Teflon or fluoro-silane, phospholipids, polydymethylsiloxane (PDMS).

As seen in FIG. 1, chamber 12 may also be in fluid connection with inlet 26 and outlet 28. Inlet 26 and outlet 28 are connected to microfluidic pump system 30 to allow for pumping of fluid into and out of chamber 12, for example, pumping of wash solution.

Each of inner electrodes 20 and outer electrodes 22 are electrically connected in a manner that allows for selection between a first mode and a second mode. In the first mode, inner electrodes 20 function together as a single collective electrode and outer electrodes 22 function together as a single collective counter electrode for the purpose of generating an electric field for dielectrophoresis. In the second mode, each of inner electrodes 20 function individually as a single working electrode and all of outer electrodes 22 function together to as a collective reference/counter electrode for each of inner electrodes 20, for the purpose of measuring impedance at each inner electrode surface.

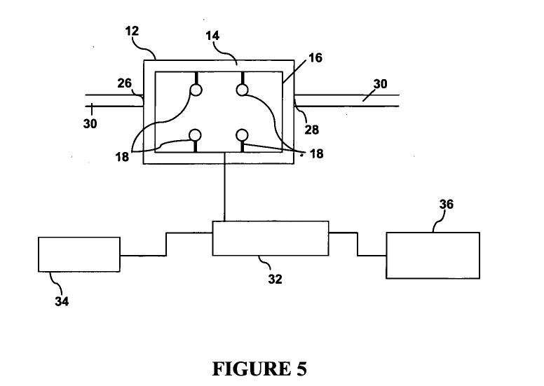

Referring now to FIG. 5, the electrode array 16 is electrically connected to a controller that allows for selection between the first mode for dielectrophoresis and the second mode for impedance measurement. The controller may be incorporated into device 10 as controller 36.

When in the first mode, controller 36 directs an AC or DC voltage from a power supply to the electrode array in order to generate the dielectrophoretic field. The power supply may be incorporated into device 10 as power supply 32, or may be external to the device. Thus, in the first mode, controller 36 directs the outer electrodes 22 to function together as a collective outer electrode and the inner electrodes 20 to function together as a collective inner electrode in order to generate a negative dielectrophoretic field in the vicinity of the electrode array 18 for concentrating target cells at electrode array 18 for capture by capture molecules 24.

When in the second mode, controller 36 allows for sensing of impedance at each individual inner electrode 20 by an electrochemical measurement unit or impedance analyser. As with the power supply, the electrochemical measurement unit may be incorporated into device 10 as electrochemical measurement unit 34 or may be external to the device. Thus, in the second mode, controller 36 directs the outer electrodes 22 to function together as a collective outer electrode and the inner electrodes 20 to function as individual working electrodes referenced against the collective outer electrode in order to measure impedance at each of the individual working electrodes 20.

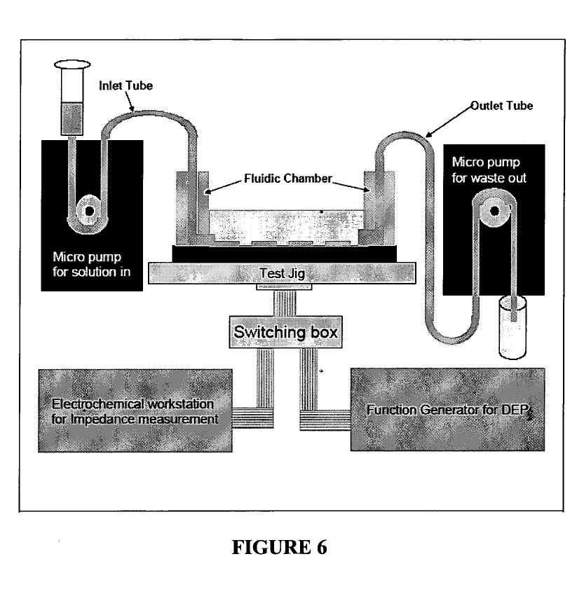

FIG. 6 is a schematic depiction of a system incorporating the device.

The above described device may be designed to allow for detection of more than one target cell type from a sample, or to detect a target cell type using more than one type of capture molecule.

Thus, the device may incorporate multiple chambers as described above, each chamber having a separate electrode array made up of electrode pairs, with each chamber having a different capture molecule or mixture of capture molecules immobilised on the surfaces of at least the inner electrodes located within the chamber. Such an arrangement allows for detection of the level of different target cells within a sample, or detection of the level of target cells having one or more particular type of cell surface marker. The chambers may be fluidically connected to allow for direct serial screening for different cell types in different chambers.

Alternatively, the device may incorporate more than one type of capture molecule within the same chamber. For example, a first type of capture molecule may be immobilised on a first portion of the inner electrodes and a second type of capture molecules may be immobilised on a second portion of the inner electrodes. In a certain embodiment, a mixture of the first and second types of capture molecules may be immobilised on a third portion of inner electrodes. Such an arrangement allows for detection of cells expressing a first cell surface marker, cells expressing a second surface marker and cells expressing both the first and second cell surface markers, while only requiring a single sample volume. Such a distribution of capture molecules may be achieved using standard techniques, including lithography controlled surface chemistry or robot liquid handling systems to deposit the relevant capture molecule on particular inner electrodes within a given electrode array.

The device as described herein is useful for detecting target cells within a sample. Thus, there is provided a method comprising contacting a fluid sample with the electrode array of the described device, applying negative DEP, capturing target cells contained within the sample with the immobilised capture molecules, measuring impedance following capture of the target cells and comparing the impedance measurement with the impedance measured in the absence of target cells to determine the number of cells within the sample.

To determine the number of cells within a sample, a fluid sample is contacted with the electrode array within the chamber of the device.

The fluid sample may be any sample in which the presence and concentration of target cells is to be detected, and may be suspended in a buffer of suitable ionic strength and conductivity for negative DEP, which buffer is compatible with intact cells. For example, the sample may be a blood, serum or body fluid sample diluted in a suitable buffer such as PBS. Alternatively, the sample may be a solid tissue sample that has been suspended in a suitable buffer solution, for example PBS, so as to disperse cells within the buffer and in such a manner so as to avoid or prevent lysis of the cells.

The fluid sample is contacted with the electrode array by depositing the sample within the chamber of the device. The sample may be deposited into the chamber directly, for example by pipette or syringe (manually or using a robotic system), or the device may be configured to allow for pumping of the sample using a microfluidic pump system. However, it should be noted that manual deposition of the sample allows for a smaller sample volume and avoids problems associated with non-specific adherence and blockage of cells within microfluidic channels and gates.

If necessary, additional buffer may be added to the chamber to assist with the trapping of the cells at the electrode surface using dielectrophoresis. The additional buffer should be suitable for suspension of intact cells, for example, an isotonic buffer. As well, the buffer should be more polarisable than the cells and able to conduct an electrical charge if it is to be used in the impedance measurement. However, if positive DEP is used, then the buffer should be less conductive than the cells.

Once the cells are loaded in the chamber, a dielectrophoretic non-uniform electric field is applied using the inner electrodes functioning together as a single electrode and the outer electrodes functioning together as a single counter electrode. The dielectrophoretic field is described here as a negative dielectrophoretic field, although a positive dielectrophoretic field may be used, as indicated above. The negative dielectrophoretic field functions to concentrate the cells in the sample, including the target cells, at the field minima, which occurs at the centre of the surface of the inner electrodes. Thus, the dielectrophoresis step provides a method of concentrating all or most cells within a sample in the vicinity of the inner electrode surface, allowing for more efficient recognition and capture of target cells by the immobilised capture molecules. Depending on the polarisability of the different cell types present in the sample, it may be possible that the dielectrophoretic force be stronger for the target cells than for the other cell types, resulting in more active concentration of the target cells on the electrodes, especially if the target cells or non-target cells are conjugated to beads.

The cells may be incubated at the electrode array for a period of time, for example, from about 5 minutes to about 20 minutes, to increase the probability that all or most of the cells will be brought to the electrode surface. During the incubation period, the dielectrophoretic field may be applied, including continuously or at intervals.

Once the cells are brought to the vicinity of the electrode array, the immobilised capture molecules will recognise and bind to target cells that display a cell surface marker that is specifically bound by the capture molecule. If more than one type of capture molecule is used, target cells present in the fluid sample will be specifically bound at an electrode upon which the capture molecule that specifically binds that particular type of target cell is immobilised.

Once the target cells have been captured by the capture molecules on the electrode surfaces, the remaining sample and non-bound cells are removed. This may be done using for example a pipette, syringe or syphon, or it may conveniently be performed using a microfluidic pump system to pump out the fluid sample from the chamber.

Following removal of the remainder of the fluidic sample, or simultaneously if a microfluidic pump system is used, the chamber and electrode array may optionally be rinsed using an impedance buffer. The impedance buffer may be the same buffer used above in preparation of the fluid sample, or it may be a different impedance buffer, and should be compatible with intact cells and with impedance measurements. Rinsing allows for removal of any remaining non-specifically bound cells and any other remaining sample components.

Impedance buffer is added to the chamber in order to perform impedance measurements. Impedance is measured for each inner electrode, functioning individually as a working electrode against the outer electrodes functioning together as a single reference electrode.

A reference impedance reading in the absence of target cells is taken in a buffer in which the impedance reading for the sample was measured.

In order to determine the concentration of target cells in the original sample, the impedance measurement obtained for each individual inner electrode after capture of target cells is compared with the impedance measured for the particular inner electrode in the absence of bound target cells. For example, the difference between impedance measured in wash buffer and impedance measured with captured target cells in the wash buffer may be calculated.

The difference in impedance may be compared with known differences calculated using known concentrations of target cells, for example as demonstrated in the examples below. That is, a standard curve of impedance may be calculated using known concentrations of target cells may be created and used as a reference to determine the concentration of target cells in a test sample in which the target cell concentration is to be determined.

The sum of the difference in impedance for all electrodes having a particular type of immobilised capture molecule provides the total number of a particular type of target cell captured for a given sample. Using the results obtained for two or more electrodes together may provide a more accurate determination of target cell concentration in the sample.

If the concentration of target cells within a sample is too low as to be below the detection limit of this method, multiple volumes of sample may be added to the chamber in order to increase the total number of cells captured on each electrode. The above steps of capture and optional wash may be repeated and a single impedance measurement taken once sufficient numbers of sample volume have been added to the chamber, or alternatively, the steps of capture, optional wash and impedance measurement may be repeated for each successive addition of sample volume to the chamber until the impedance measurement is within the detection range for the method. If desired, a longer wash step, using a larger wash volume and higher flow rate may be performed after addition of the final batch of sample volume in order to ensure that non-specific cells are removed prior to a final impedance measurement.

If desired, the device may be regenerated for subsequent use by removing the captured target analyte particles and immobilised capture molecules, for example by mechanical scrubbing or using bleach or NaOH solution. The surfaces may be cleaned using isopropyl alcohol, de-ionised water and oxygen plasma such as used when stripping a photoresist layer. Sterilization cleaning methods may also be used. New surface chemistry can then be applied and the device can then be used again for a new test.

The above-described methods and devices are useful in various medical applications, including for determining treatment regimen and treatment efficacy. For example, when the device and method are used to detect EPCs from a blood sample, a physician may use the results to determine the effectiveness of a given treatment, including medications to increase levels of EPCs. As well, a physician may use the results of EPC count to determine the type of stent to deploy in a patient.

The methods and devices may be used for real-time in situ monitoring of cell growth.

Following capture of target cells on the surface of the electrodes, and optional washing, cells are allowed to fully attach to the electrode surface if cell attachment is required for cell growth. An initial impedance measurement for each working electrode is recorded. The cells are allowed to incubate under conditions that allow for cell division, and then one or more impedance measurements are taken under the growth conditions. The total number of cells at any given time point can be calculated based on the change in impedance from the initial impedance measurement. This approach may be used even without a capture molecule, using the DEP to direct the cells to the centre of the electrode surface.

The methods and devices may be used for real-time in situ monitoring of drug and toxicity effects on cells, or monitoring of cell culture processes, for example cell spreading and confluence under certain growth conditions.

Following capture of target cells on the surface of the electrodes, and optional washing and cell attachment, real-time in situ impedance can be measured to monitor cell growth. An initial impedance is recorded at each working electrode, and a supplement such as a drug, a toxic test compound, a growth factor, a substrate, growth medium or other supplement may be added to the chamber following the initial measurement. The cells are allowed to incubate, including under conditions that allow for cell division if desired, and then one or more impedance measurements are taken under the test conditions. The total number of cells at any given time point can be calculated based on the change in impedance from the initial impedance measurement. This approach may be used even without a capture molecule, using the DEP to direct the cells to the centre of the electrode surface.

Following capture of target cells on the surface of the electrodes, and optional washing and cell attachment, real-time in situ electrochemical signal can be measured to monitor drug efflux, or the release of metabolites substrates from the cells under certain drug or factor stimulation conditions.

The above-described devices, methods and uses are further exemplified by way of the following non-limited examples.

### EXAMPLES

### Example 1

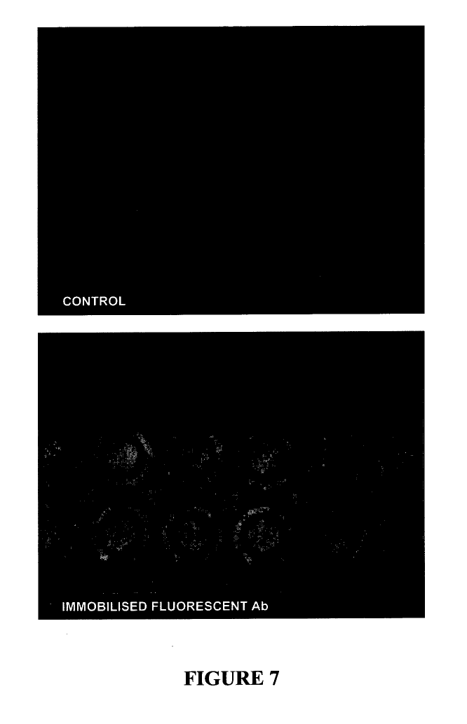

FIG. 7 shows florescent images of the antibody specifically immobilized on the electrode areas of the microchip, which is surrounded by a silicon oxide biocompatible layer that has been coated with a cell-repellent material to prevent non-specific adhesion of anti-CD34 antibodies prior to immobilization and of cells during cell trapping step.

The surface coating process and polyethylene glycol (PEG) passivation were adapted from work done by M. Zhang's group (Mandana, V., Wickes, B. T., Castner, D. G., Zhang, M. (2004) Biomaterials 25(16), 3315-3324; Lan, S., Veiseh, M., Zhang, M. (2005) Biosensors and Bioelectronics 20(9), 1697-1708). A mixture of COOH-terminated alkanethiols (a 20 mM solution of 1/10 v/v mercapto-undecanoic acid (MUA)/mercapto-propionic acid (MPA) in ethanol) were used to create a self-assembled monolayer (SAM) on the gold electrodes that can be further modified to bind to NH₂-amino acids of proteins through activation with N-(3′-dimethylaminopropyl)-N′-ethylcarbodiimide hydrochloride (EDAC)/N-hydroxysuccinimide (NHS) The silicon oxide surface surrounding the electrodes was passivated with a silane-PEG SAM that prevented protein adsorption and cell attachment. The process differed on the following steps: the substrates were cleaned with isopropanol, water and a plasma O₂ treatment (60% O₂, 100 W for 50 s) instead of piranha solution; the incubation in the thiol solution to form the COOH-terminated self-assembled monolayer (SAM) on the gold electrodes was reduced to 6 hours. 50 μl of CD34-fluoroisothyocyanate (FITC) antibody solution (0.1 mg/ml in PBS) was then incubated on one of the chips for 45 minutes and rinsed 3 times with PBS. The other chip was stored at 4° C. after application of the PEG coating and was not activated. This is just one example of possible chemistries and patterning methods that can be used to obtain an electrode array with appropriately immobilised capture molecules.

FIG. 7 shows specific binding of the fluorescent antibody on the gold surface and low non-specific binding on the rest of the chip.

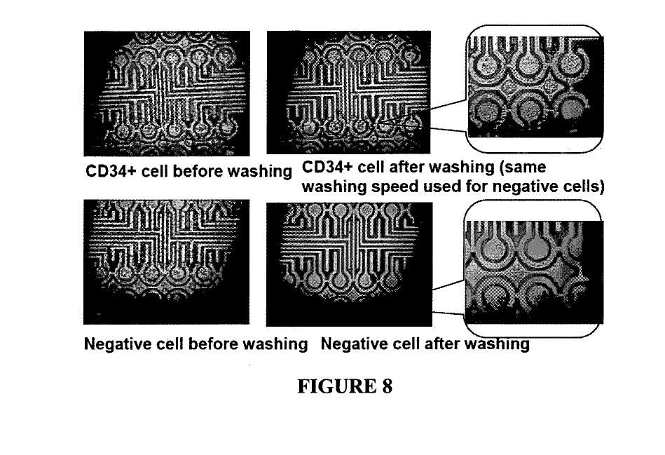

To demonstrate that the device is effective at specifically trapping target cells, FIG. 8 shows that both cell types (target (CD34+) cells that bind to the anti-CD34 antibody attached to the inner electrode surface and non-specific (CD34−) cells) settled on the chip surface during a cell incubation step that involved negative DEP to concentrate cells at the electrode surfaces. After a phosphate buffer saline (PBS) solution wash, the CD34+ cells were retained on the inner electrode surfaces whereas CD34− control cells were washed away, demonstrating the specificity of the cell trapping.

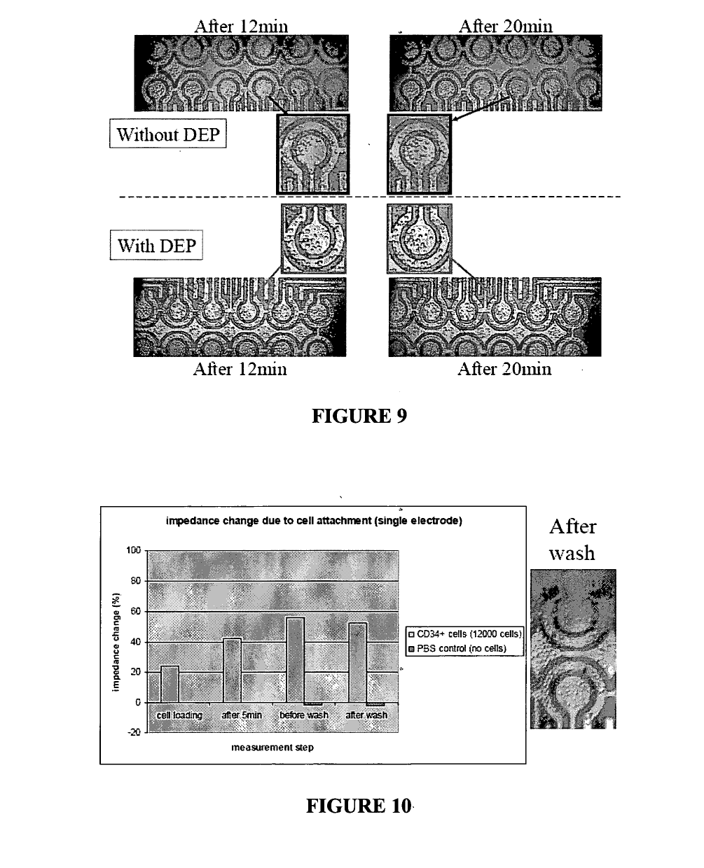

Approximately 1.2×10⁴ CD34+ target cells were loaded inside the chamber and observed under the microscope (FIG. 9). Following DEP (2 MHz, 1.5 Vpp—bottom set of pictures), the sedimentation of the cells towards the inner electrode surface reached saturation after only 12 minutes. No difference for the same electrode was seen after 12 minute or 20 minute (enlarged panels, bottom) incubations and the electrode surfaces were almost fully covered. In contrast, when no DEP was used to concentrate cells at the electrode surfaces, the number of cells reaching the surface between 12 and 20 minutes (enlarged panels, top) is noticeably larger to an extent that would effect impedance measurements. These results demonstrate that DEP can accelerate and direct cell trapping on the electrode surface with immobilized antibody.

FIG. 10 shows the impedance signal as monitored through various stages of the process for a single inner electrode on the chip. Impedance change (%) is calculated as the percentage of difference between the impedance signal measured at a given time point and the signal measured at the initial calibration step using PBS and prior to cell loading (real, at log 5.58 Hz). The impedance measured after loading 12000 CD34+ cells in PBS inside the chamber with CD34+ antibody immobilised on the inner electrode surface shows an increase of more than 20%. After 5 minutes incubation the cells started to settle on the electrode surface, contributing to the increasing impedance signal. Similar results are seen just prior to washing following a 20 minutes incubation, when the cells have completely settled on the electrode surface. Finally, after a washing step, the target CD34+ cells remain trapped on the surface by the immobilised antibody and the impedance signal increases by more than 50%. A control experiment is also shown in which the same process was applied to a chip containing only PBS (no cells). Results show insignificant signal change throughout the control experiment, confirming that the impedance change described is due to cell attachment to the antibody-coated surface.

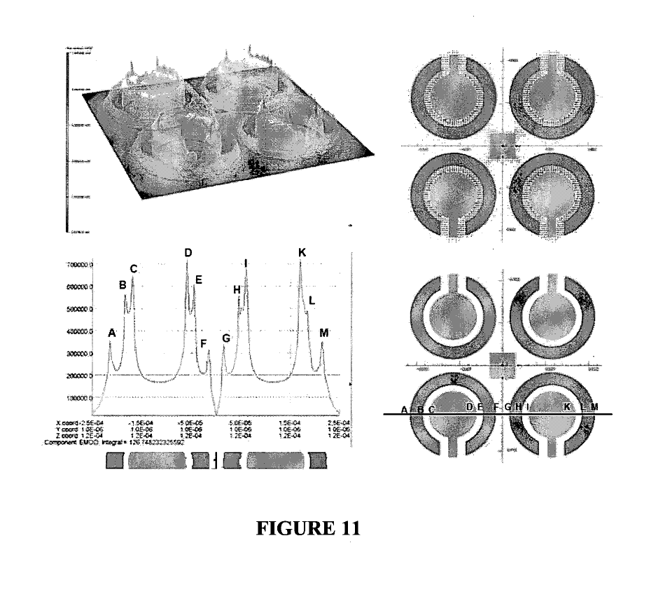

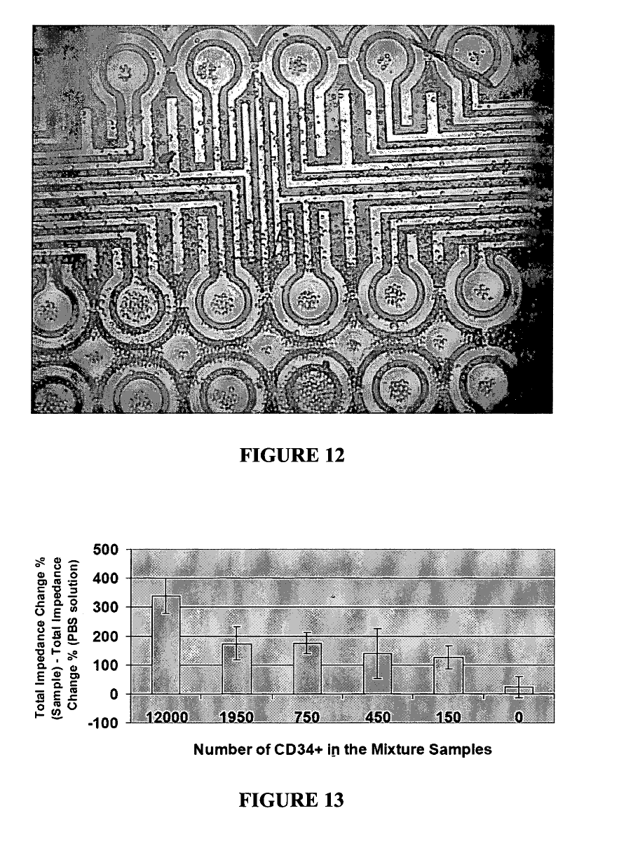

FIG. 11 shows the simulation results for electrical field distribution across the electrode pairs as shown. As seen from the results, the inner electrode surface has a lower electrical field, which will direct cells toward the electrode surface during the application of negative DEP. FIG. 12 is a micorograph showing CD34+ cells trapped on the electrode centres following negative DEP.

### Example 2

FIG. 13 demonstrates the results of testing the lower detection limit of the device using a sample containing a total of 15,000 cells with Jurkat cells as non-target cells and CD34+ cells as target cells. As can be seen, at least a lower limit of 150 CD34+ cells in a total of a mixed sample containing 15,000 cells can be detected in a single batch loading.

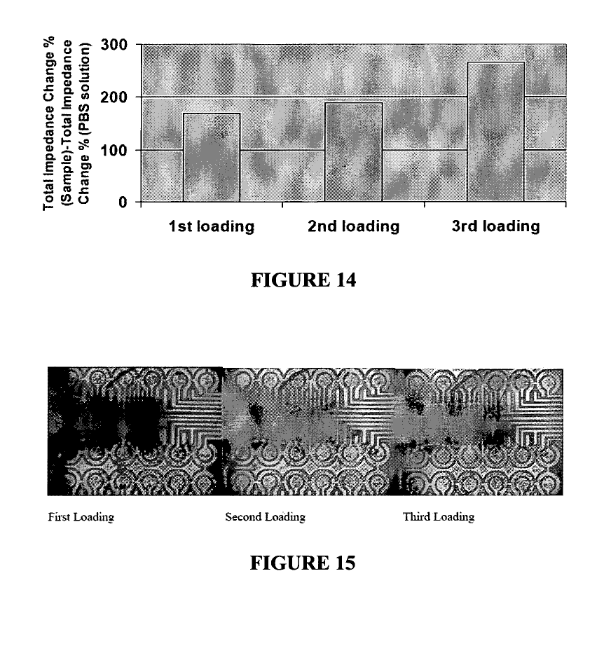

FIGS. 14 and 15 demonstrate the improved detection using multiple batch loading of cells. For each batch, a mixture of Jurkat and CD34+ cells (for a total of 15,000 cells containing 750 CD34+ cells) were loaded into the chamber. The results indicate that the CD34+ cells are retained on the inner electrode from batch to batch loading, cell trapping and washing procedures, resulting in overall increase in % impedance change with increasing number of batches loaded. Thus, if a single batch contains a target cell concentration that falls below the lower detection limit, multiple batch loading may be used to allow for loading of sufficient cells to exceed the detection threshold.

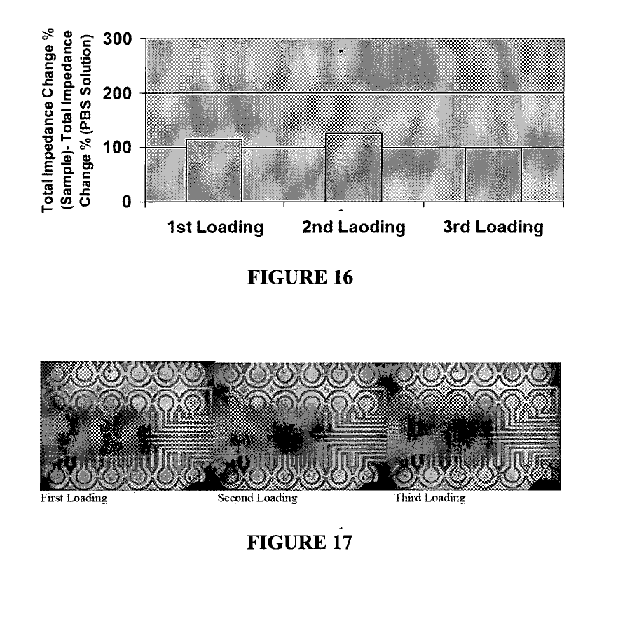

FIGS. 16 and 17 show the results for a similar experiment using only Jurkat cells. The results indicate that % impedance change does not increase with increased loading of batches of negative control cells.

### Example 3

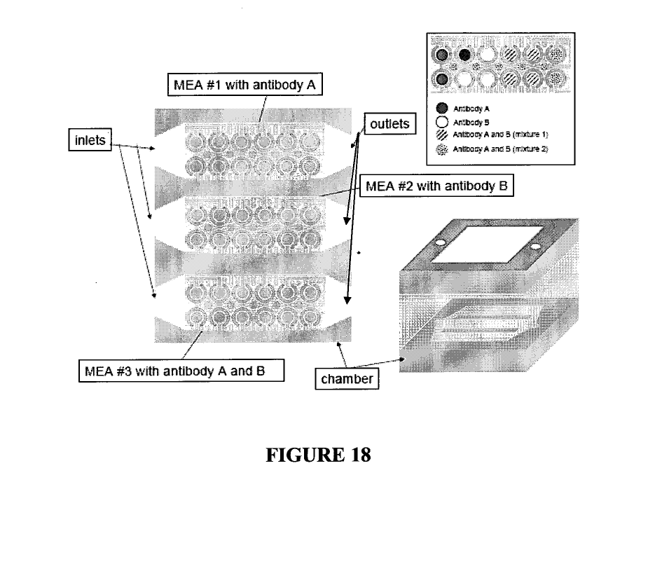

The described method is performed on a device having three separate chambers each with a separate electrode array. Chamber 1 has antibody A immobilised on the electrode surfaces, chamber 2 has antibody B immobilised on the electrode surfaces, and chamber 3 has antibodies A and B immobilised on the electrode surfaces, as shown in FIG. 18.

Thus, in chamber 1, cells expressing antigen A (specifically bound by antibody A) and antigen A and B together will be detected and quantified; in chamber 2, cells expressing antigen B (specifically bound by antibody B) and antigen A and B together will be detected and quantified; and in chamber 3, cells expressing antigen A, antigen B or antigen A and B together will be detected and quantified.

In order to obtain the levels of the various cells of interest, the following calculations are carried out on the signals obtained from the impedance measurements: subtracting the impedance measurements obtained from chamber 1 from those of chamber 3 provides the concentration of target cells expressing antigen B only; subtracting the impedance measurements obtained from chamber 2 from those of chamber 3 provides the concentration of target cells expressing antigen A only; subtracting the impedance measurements obtained from chamber 3 from the sum of the impedance measurements obtained from chambers 1 and 2 provides the concentration of target cells expressing both antigens A and B.

Alternatively, multiple types and combinations of capture molecules may be immobilised on different electrodes within the same electrode array in a single chamber (inset panel of FIG. 18).

Following the described method, using either single batch or multi-batch application of sample volumes, target cells expressing the particular cell surface markers are retained specifically on the electrode(s) coated with the corresponding antibodies. The signal from each electrode is recorded individually and compiled to assess the relative quantity of each cell type (cells that have a specific combination of markers). Depending on the expected concentration of the target cells, the signals from electrodes covered with the same antibody are summed together to increase the sensitivity.

### Example 4

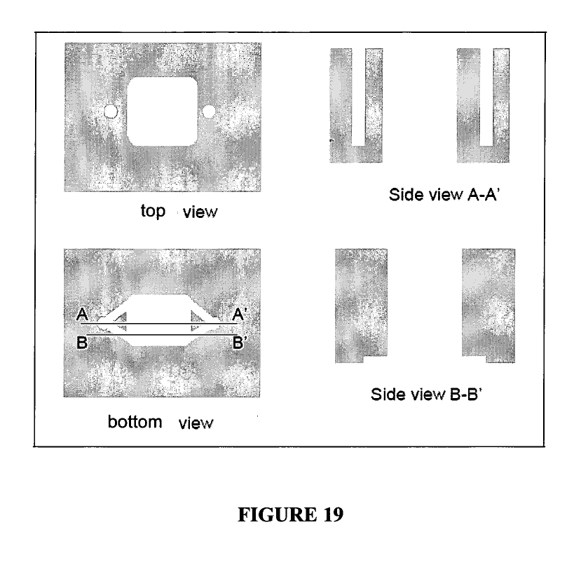

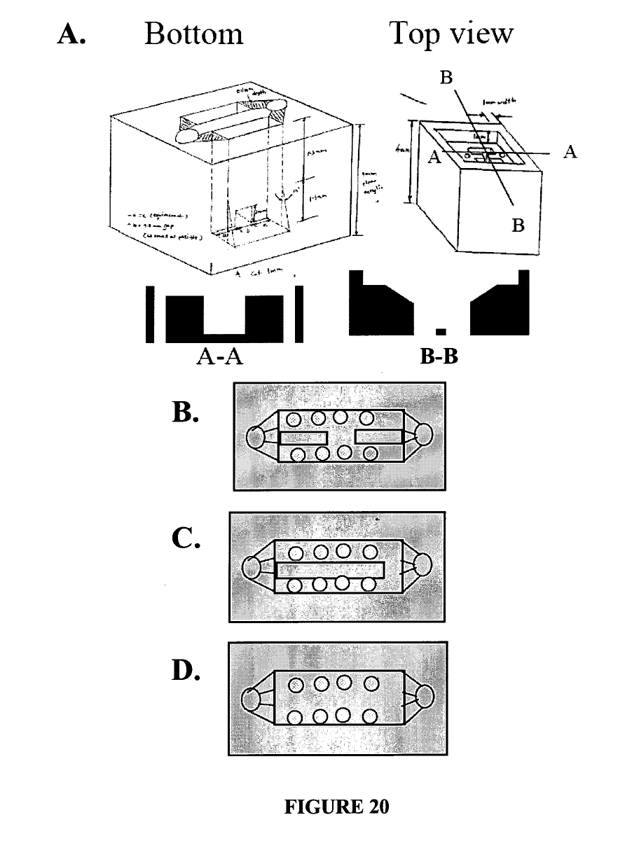

Various possible configurations of the chamber are shown in FIGS. 19 and 20. FIG. 19 shows top, bottom and cross sectional views A-A′ and B-B′ of a non-split chamber design, also showing microfluidic channels for connection to inlet and outlet ports. In FIG. 20, panel A. shows bottom and top views as well as cross section A-A and B-B views of an H shaped chamber. Panels B., C., and D. show top views of H shaped, U shaped and non-split chamber designs.

### Example 5

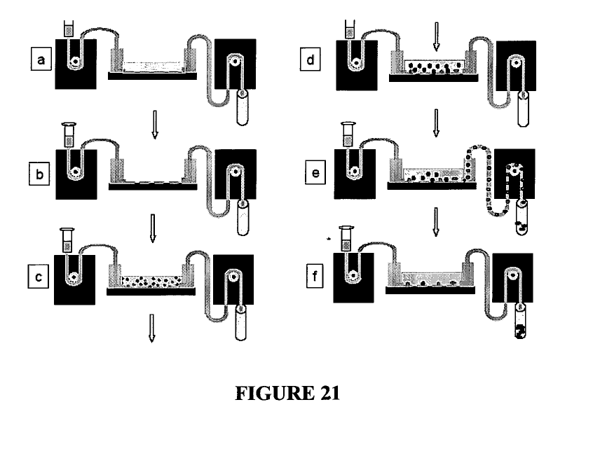

FIG. 21 is schematic flow diagram depicting one embodiment of the method.

In panel a), a PBS solution is filled into the chamber and an initial impedance measurement is performed for each individual working electrode.

In panel b), the PBS solution is pumped out of the chamber via the outlet using the microfluidic pump system.

In panel c) a sample of peripheral blood mononuclear cells containing EPCs is injected suspended in a conductive medium (PBS) into the chamber in a single batch.

In panel d) negative DEP is applied to concentrate cells in the sample to the bottom of the chamber where the electrode array is located, and specifically to concentrate cells at the centre of the working electrodes, the surfaces of which are covered by pre-immobilised EPC-specific antibodies. The surfaces surrounding the electrodes are previously coated with cell-repellent materials. The cells are incubated to allow the antibodies to specifically bind the EPCs.

In panel e) unattached cells (non-EPC) are washed from the chamber by pumping in wash solution from the inlet, through the open chamber and out the outlet.

In panel f) the impedance of individual working electrodes is measured and the change in impedance (from the initial impedance value measured in PBS) for each working electrode is calculated. The individual working electrode impedance change correlates with the number of EPCs on the particular electrode. The sum total impedance change from all of the individual electrodes correlates with the number of EPCs that were captured by the system, and can be used to calculate the concentration of EPCs in the initial sample.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

As used in this specification and the appended claims, the singular forms “a”, “an” and “the” include plural reference unless the context clearly dictates otherwise. As used in this specification and the appended claims, the terms “comprise”, “comprising”, “comprises” and other forms of these terms are intended in the non-limiting inclusive sense, that is, to include particular recited elements or components without excluding any other element or component. Unless defined otherwise all technical and scientific terms used herein have the same meaning as commonly understood to one of ordinary skill in the art to which this invention belongs.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

1. A device for detecting target analyte particles in a sample, comprising:
a chamber having an interior surface;
an electrode array on said interior surface, said electrode array comprising one or more electrode pairs, each of said one or more electrode pairs comprising an inner electrode and an outer electrode at least substantially surrounding the inner electrode;
one or more capture molecules immobilised on a surface of each of said inner electrodes for capturing said target analyte particles; and
a controller operably interconnected with said electrode array to selectively
(i) apply a voltage to said outer electrodes and said inner electrodes to generate a dielectrophoretic field in the vicinity of the electrode array for concentrating target analyte particles at said electrode array for capture by said capture molecules; and
(ii) sense impedance changes at each inner electrode, to detect captured target analyte particles.

2. The device of claim 1 wherein the dielectrophoretic field is a negative dielectrophoretic field.

3. The device of claim 1 further comprising an inlet and an outlet of said chamber, each of said inlet and outlet in fluid communication with a microfluidic pump system.

4. The device of claim 1 wherein the area of the interior surface not covered by electrodes is coated with an analyte-repellent material.

5. The device of claim 1 comprising two or more electrode pairs and wherein a first portion of the inner electrodes has a first type of one or more capture molecules immobilised thereon and a second portion of the inner electrodes has a second type of one or more capture molecules immobilised thereon.

6. The device of claim 1 wherein the analyte particles are cells, bacteria, viruses, proteins, nucleic acids, microbeads or nanobeads.

7. The device of claim 6 wherein the analyte particles are cells.

8. The device of claim 1 wherein the one or more capture molecules are antibodies.

9. The device of claim 8 wherein the antibodies are anti-CD34 antibodies and the target analyte particles are endothelial progenitor cells.

10. A method of determining concentration of target analyte particles in a sample, comprising:
adding a sample volume to a chamber of a device, said chamber having an electrode array located on an interior surface of said chamber, said electrode array comprising one or more electrode pairs, each of said one or more electrode pairs comprising an inner electrode and an outer electrode surrounding the inner electrode, each of said inner electrodes having one or more capture molecules immobilised thereon;
applying a voltage to said outer electrodes and said inner electrodes to generate a dielectrophoretic field in the vicinity of said electrode array, thereby concentrating target analyte particles present in the sample volume at said electrode array;
capturing said target analyte particles by specifically binding said target analyte particles with said capture molecules and forming a remaining sample volume;
replacing the remaining sample volume in the chamber with an impedance buffer solution suitable for conducting impedance measurements;
measuring impedance at each inner electrode;
and comparing the measured impedance with impedance measured in the absence of any target analyte particles and correlating any difference in impedance obtained with the concentration of target analyte particles in the sample.

11. The method of claim 10 wherein the dielectrophoretic field generated is a negative dielectrophoretic field.

12. The method of claim 10 further comprising incubating the sample volume for a period of time following application of the dielectrophoretic field and prior to replacing the remaining sample volume.

13. The method of claim 10 further comprising washing the chamber with a wash buffer solution prior to adding the impedance buffer solution.

14. The method of claim 10 wherein the electrode array comprises two or more electrode pairs and wherein a first portion of the inner electrodes has a first type of one or more capture molecules immobilised thereon and a second portion of the inner electrodes has a second type of one or more capture molecules immobilised thereon, and wherein said comparing is performed separately for the measured impedance obtained for the first portion of inner electrodes and for the measured impedance obtained for the second portion of inner electrodes.

15. The method of claim 10 wherein the analyte particles are cells, bacteria, viruses, proteins, nucleic acids, microbeads or nanobeads.

16. The method of claim 15 wherein the analyte particles are cells.

17. The method of claim 10 wherein the one or more capture molecules are antibodies.

18. The method of claim 17 wherein the antibodies are anti-CD34 antibodies and the target cells are endothelial progenitor cells.

19. The method of claim 10 wherein said sample volume is a first sample volume and further comprising adding a second sample volume after said adding and before said measuring, and repeating said applying and said replacing prior to measuring the impedance.

20. The method of claim 10 wherein said sample volume is a first sample volume and further comprising adding a second sample volume after said measuring and repeating said applying, said replacing and said measuring.

21. The method of claim 10 wherein the analyte particles are cells, the method further comprising, after said measuring, incubating the cells in the chamber under conditions that allow for cell growth, and then repeating said applying, said capturing, said replacing, said measuring and said comparing.

22. The method of claim 10 wherein said measuring comprises measuring a first impedance, the method further comprising incubating the captured target analyte particles in the impedance buffer for a pre-determined period of time, measuring a second impedance and then comparing the second measured impedance with the first measured impedance and correlating any difference in impedance obtained with the change in the sample over the pre-determined period of time.

23. The method of claim 10, wherein said measuring impedance is measuring a second impedance, the method further comprising, prior to said measuring the second impedance:
measuring a first impedance at each inner electrode; and
incubating the captured target analyte particles in the impedance buffer for a pre-determined period of time;
wherein said reference measured impedance is said first measured impedance and said correlating further comprises correlating any difference in impedance obtained with an increase in concentration of target analyte particles in the sample.

24. The method of claim 22 wherein said incubating is performed under conditions that allow for cell growth.

25. The method of claim 23 further comprising repeating said applying prior to said measuring said second impedance.

26. The method of claim 21 further comprising adding a supplement prior to said incubating.
